(19) United States
(12) Patent Application Publication
(10) Pub. No.: US 2007/0140310 A1
(43) Pub. Date: Jun. 21, 2007

(54) Identification of materials by non destructive testing

(76) Inventors: Peter E. Rolton, Hogham Ferrers (GB); George S. Ballard, Swaffham Bulbeck (GB)

Correspondence Address: BARNES & THORNBURG LLP, P.O. BOX 2786, CHICAGO, IL, 60690-2786, US

(21) Appl. No.: 10/542,750

(22) PCT Filed: Jan. 20, 2004
(86) PCT No.: PCT/GB04/00221

§ 371 Date: Oct. 2, 2006

(30) Foreign Application Priority Data
Jan. 20, 2003 (GB) 0301231.7

(51) Int. Cl. G01N 25/18

(52) U.S. Cl. 374/44

(57) ABSTRACT

In a method of non-destructive testing of a panel of composite insulation material (1), a portion of a surface (2) of a test panel is heated by applying a heat source for a predefined time or until a predefined amount of energy has been imparted to the panel. The heat dissipation from the surface (2) of the panel is then measured over time in order to produce a heat dissipation characteristic for the test panel, which is then compared with reference heat dissipation characteristics from panels of known composition in order to provide an initial indication of the composition of the panel. The surface (2) of the panel is then struck with a tuned hammer in order to pass a pulse of energy therethrough which generates vibrations within the panel. These vibrations are again monitored over time in order to produce a characteristic vibratory modes for the panel, which is then compared with reference data from panels of known composition in order to provide a confirmation of the composition of the test panel.

The present invention relates to non-destructive methods of identifying materials and in particular to methods of non-destructively identifying composite insulation material.

Panels manufactured from composite insulation material have been widely used for a number of years in the food industry to make insulated chambers for the cold storage of food stuffs. Until recently, however, there has been no industry standard for the actual composition of such panels. Instead, panels have typically been manufactured by small scale operations each of whom have their own preferred “in house” material composition and manufacturing systems, and as a result, panels incorporating a variety of insulation materials including expanded and foamed polymers, mineral wool and other materials of low thermal conductivity, sandwiched between thin steel sheets, exist.

Due to the inflammable nature of some of the material which are commonly used in these composite insulation materials, and the toxic nature of the gas emitted when certain of these materials burn, fire brigades are now refusing to enter and fight fires in buildings which use these composite insulation materials unless it can be shown that the composition of the insulation material used in the building does not pose an unacceptable risk to the fire-fighters. If the owner/tenant of the building is not able to supply such information, the fire fighters will only fight the fire from a “safe” distance, which usually results in much more major damage to the premises and its contents than would have been the case if the fire had been fought from inside. It clearly, then, follows that the risk of a large amount of damage in the event of a fire is significantly increased in premises which are not able to supply to the fire brigade information on the composition of the insulation material which they utilise for cold storage chambers, and, having recognised this higher risk assessment, insurance companies are now taking account of the presence and type of composite insulation material in buildings when calculating insurance premiums for both building and contents insurance. In the event that the proposer is unable to provide this information, the insurance premia are significantly increased to reflect the insurance company's perceived greater risk, often to a level which makes insurance prohibitively expensive to the proposer.

The problem which most users of composite insulation material face is, then, that due to the fact that they are erected by small scale local companies, who do not normally have any records which indicate the actual composition of the panels which have been installed and are unable to trace the manufacturer to obtain that information. At present, then, the only way to identify the material is to take a core sample and analyse it, but this process destroys the integrity of the panel and hence necessitates its replacement. There is, then, a need for a method of identifying the composition of composite insulation material which does not involve physically damaging the panels, and in particular does not require removing, penetrating or otherwise disrupting the outer skin of the panel.

In accordance with one aspect of a presently preferred embodiment of the invention, there is provided a method of non-destructive testing a panel of composite insulation material comprising the steps of heating a portion of a surface of the test panel, measuring the heat dissipation from said surface over time in order to produce a heat dissipation characteristic for said test panel, and comparing said heat dissipation characteristic with heat dissipation characteristics obtained from panels of known composition, hereinafter referred to as reference heat dissipation characteristics, in order to identify the composition of the test panel.

A method of non-destructive testing composite insulation material in accordance with the invention has the advantage that it enables the composition of the panels of insulation material to be ascertained quickly, reliably and easily without the need for intrusive or destructive procedures to be carried out, so that panels will only need to be replaced if they are found to include or be composed of undesirable materials.

Preferably, the panel is heated by applying a heat source, in particular a local or point heat source, to a portion of one surface thereof for a pre-defined time or until a pre-defined amount of energy has been imparted to the panel. This may be achieved particularly advantageously, in the case of panels having outer skins formed of metal, by using an electro-magnetic coupler. More particularly, the electromagnetic coupler may include coils wound on a magnetically susceptible core constructed as an incomplete magnetic circuit, and may be used in conjunction with a wave generator and amplifier which operates to excite the coils. Upon bringing the coupler into close proximity with the panel, the magnetic circuit completes with magnetic flux passing through the outer skin, causing electrical eddy currents to be generated which heat the skin. This arrangement has the advantage that the amount of heated added to the panel can be measured particularly accurately, thereby enabling the test conditions to be re-produced very easily.

Of course, it is also possible utilise other systems for heating the panel within the scope of the invention. For example, for panels which do not have a conductive metal skin, a radiant heat source may be applied against the surface of the panel for a pre-defined time in order to raise the temperature of the panel at the application point by a pre-defined amount.

The heat dissipation from the surface is preferably measured by viewing the portion of the surface of the panel which is heated and measuring the thermal radiation emitted therefrom. It has been found to be particularly advantageous to take measurements at regular time intervals throughout the thermal decay cycle of the panel until it has returned to, or near to, ambient temperature, preferably at least 10 readings being taken at equally spaced time intervals. However, continuous readings may also be taken.

A thermal imaging device is preferably used to monitor the thermal radiation emitted from the panel within a viewing area which is centered on the point of application of the heat source. It has been found to be particularly effective for the viewing area of the imager to be three times the diameter of the area to which the heat source/local heating device is applied.

According to another aspect of the invention, there is provided a method of non-destructive testing a panel of composite insulation material comprising the steps of striking the surface of the test panel in order to pass a pulse of energy therethrough, measuring the vibrations within the panel over time in order to produce characteristic vibratory modes for the test panel, and comparing said characteristic vibratory modes with characteristic vibratory modes obtained from panels of known composition, hereinafter referred to as reference characteristic vibratory modes, in order to identify the composition of the test panel.

Preferably, the surface of the panel is struck with a tuned hammer, this having the advantage of producing in the panel an energy pulse at a known centre in particular frequency centre frequency and of narrow band-width, thereby improving the accuracy of the test results. The resulting vibrations within the panel are preferably monitored using an acoustic sensor, capable of responding to frequencies at least one octave over the anticipated resonant frequencies and in particular which takes vibration measurements capable of defining the amplitude overtime and frequencies of the vibratory modes.

It has been found that certain panel types produce similar heat dissipation or characteristic vibratory modes even though they are composed of insulation material having different compositions and this makes the unique identification of these panels using either of the two methods alone according to the invention difficult.

According to a further, particularly preferred embodiment of the invention, therefore, both the heat dissipation test according to the first aspect and the vibratory mode test according to the second aspect of the invention are carried out on each panel in order to obtain characteristic curves of both the heat dissipation and the vibratory mode qualities of the panel, the results again being compared with curves and characteristics obtained from panels of known composition in order uniquely to identify the composition of the test panel.

This approach has the advantage that it enables all known panel types uniquely to be identified, even if either their heat dissipation characteristic or their vibratory mode characteristic is not completely unique.

In order that the invention may be well understood, there will now be described an embodiment thereof, given by way of example, reference being made to the accompanying drawings, in which:

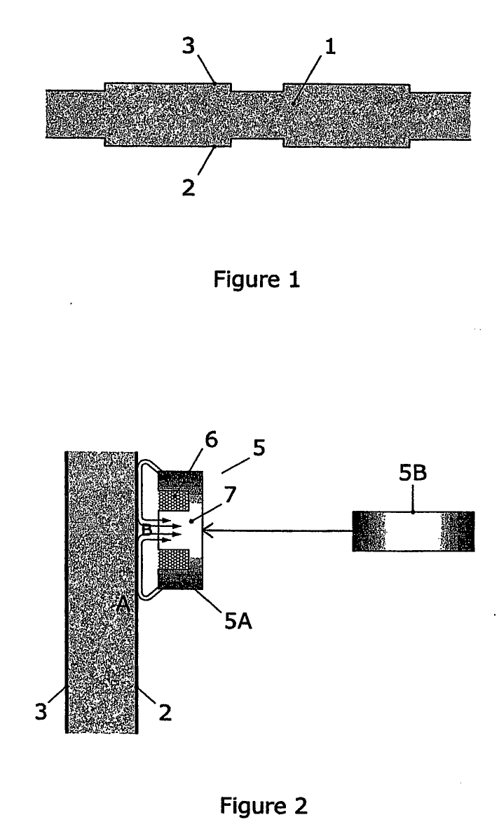

FIG. 1 is a section through a typical insulation panel of the type on which the present invention is intended to be used;

FIG. 2 is a schematic view of a heating device which may be used to provide localised heating to a surface of the test material;

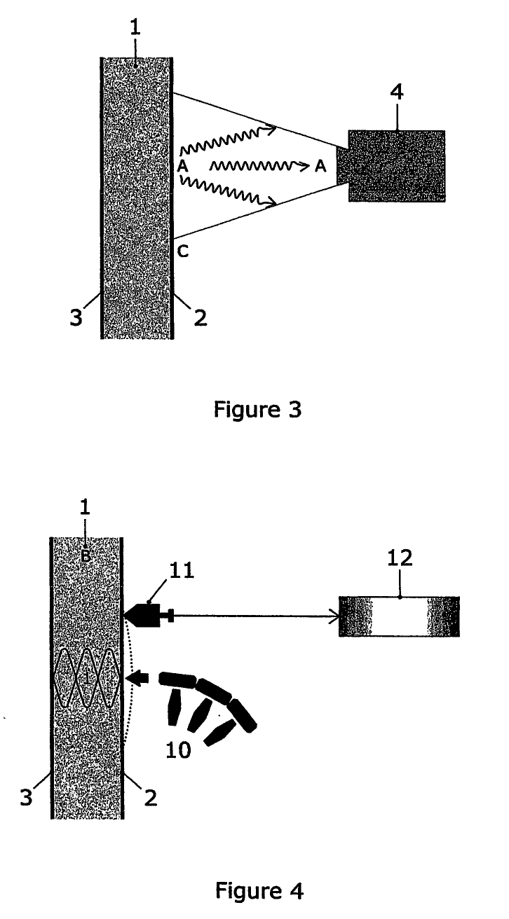

FIG. 3 is a schematic view of a thermal imaging device arranged to measure the radiation emitted from the heated surface of the test material; and

FIG. 4 is a schematic view of an acoustic device which can be used with the method of the invention to provide a supplementary or alternative test of the composition of the material.

Referring first to FIG. 1, there is shown a section through a typical insulation panel used to construct an insulated chamber for the cold storage of food stuff and the like. The panel is composed of a composite insulation material 1, which might include expanded and foamed polymers, mineral wool and other materials of low thermal conductivity, sandwiched between outer thin steel sheets 2, 3. These outer sheets 2, 3 are typically profiled and coated or painted.

A thermal imaging device 4 is positioned in front of and a short distance away from the outer surface of one of the steel sheets 2 and arranged to view a circular area C-C′ as illustrated in FIG. 3. Once the thermal imaging device 4 has been positioned, a heating device 5 which provides local heating, is applied against the outer surface of the steel sheet 2 substantially in the centre of the circular viewing area of the thermal imaging device 4. The heating device 5 preferably comprises an electro-magnetic coupler 5A which includes coils 6 wound on to a magnetic core 7 constructed with an incomplete magnetic circuit, and a combined wave generator and amplifier 5B which operates to excite the coupler 5A. When the coupler 5A is brought into close proximity to the steel sheet 2, its magnetic circuit is completed with magnetic flux 8 passing through the sheet 2. Eddy currents are thereby generated in the sheet steel lying in the magnetic pathway, which eddy currents generate heat in the steel sheet 2.

The heating device 5 is applied to the surface until a predefined amount of energy has been transferred, or until a fixed current has been passed for a predefined time period; and the current is then immediately switched off and the device removed from the surface of the sheet 2 so as to allow the thermal imager 4 to take unobstructed measurements of the radiation emitted from within the viewing area C-C′. It has been found to be particularly effective for the viewing area C-C′ of the thermal imager 4 to be three times the diameter of the are to which local heating device 5 is applied.

Once the heating device 5 has been removed, the thermal imaging device 4 records the infra-red radiation A′ emitted from the viewing area toward the thermal imaging device 4 by taking measurements at regular time intervals through the thermal decay cycle of the steel sheet 2 until it has returned to approximately the ambient temperature. Preferably, at least ten readings should be taken at equally spaced time intervals.

Heat is lost from the steel sheet 2 in one direction to the surrounding atmosphere, and hence towards the imaging device 4, by radiation from its surface, and by conduction through the insulating material 1 towards the other steel sheet 2. The heat lost from the surface of the steel sheet to the atmosphere is common to all panel types and compositions, whereas the heat lost to the insulation is specific to the insulation material used. Thus, the relative proportions in which the heat is lost in these two ways is characteristic of the insulation material which is sandwiched between the steel sheets 2, 3. Since the total amount of energy applied to the steel sheet 2 is known, the readings taken by the thermal imaging device 4 are characteristic of the amount of energy conducted into the insulating material, and by comparing these results to with the characteristic curves generated by measuring the heat dissipation from panels whose composition is known, the composition of the test material can be ascertained.

It is, however, possible that two panels of differing composition could have substantially the same heat dissipation characteristic making definitive identification using the above described system more difficult. In order to overcome this, a second test is also carried out using the apparatus illustrated in FIG. 4 to take an acoustic measurement of the panel. The surface of the steel sheet 2 is struck with a tuned hammer 10, which passes a pulse of energy through the insulation material 1 and causes the steel sheet to vibrate as a diaphragm as shown by the dotted line in FIG. 4. The energy pulse passes through the insulation material 1 and is reflected back by the steel sheet 3 forming the opposite skin of the panel at a speed which is governed by the acoustic velocity of the insulation material 1 and at an amplitude governed by its acoustic attenuation. Depending upon the elastic properties of the insulation material 1, the energy pulse may also cause it to resonate. The damping of the vibration of the steel sheet will also depend upon the elastic properties of the insulation material 1, and the difference in moduli between the steel skin and the insulation material 1.

An acoustic sensor 11 is used to measure all the vibrations in the steel sheet 2 and these readings are recorded continuously by a processor 12. The results are then compared with sets of results taken from panels of known composition in order to identify the likely composition of the test panel. In the event, then, that the results of the heat dissipation test are not fully conclusive, the results of the acoustic test can then be used in combination with the results of the heat dissipation test in order uniquely to identify the test material.

Whilst the above embodiment of the invention described above utilises both a heat dissipation test and an acoustic test in order to identify the composition of a test panel, the invention may also be operated using one or other test alone in order to identify the composition, although in certain circumstances it may not then be possible uniquely to identify the material but instead merely to identify it as having a composition falling within a particular range, as being one of a small number of materials, as including a particular material within its composition, etc.

1. A method of non-destructive testing of a panel of composite insulation material comprising the carrying out of a first test including the steps of heating at least a portion of a surface of the test panel, measuring said heat dissipation from said surface over time in order to obtain a heat dissipation characteristic for said test panel, and comparing said heat dissipation characteristic with reference heat dissipation characteristics in order to identify the composition of the test panel; and a second test including the steps of striking the surface of the test panel in order to pass a pulse of energy therethrough, measuring the vibrations within the panel over time in order to produce a characteristic of the vibratory modes of the test panel, and comparing said characteristic vibratory modes with reference vibratory modes in order to identify the composition of the test panel.

2. A method according to claim 1, wherein said portion of the surface of the test panel is heated by applying a heat source to said portion of the surface for a pre-defined time or until a pre-defined amount of energy has been imparted to the panel.

3. A method according to claim 2, wherein the heat source is a local or point heat source.

4. A method according to claim 1, wherein said heating of said surface of the test panel is effected by passing magnetic flux through a metallic outer skin of the test panel so as to induce electrical eddy currents within said skin which heat the surface of the test panel.

5. A method according to claim 4, wherein said eddy currents are generated by positioning an electro-magnetic coupler proximate to said surface of said test panel, the electro-magnetic coupler comprising coils wound on a magnetically susceptible core constructed as an incomplete magnetic circuit so that, upon locating the coupler close to the test panel, the magnetic field interacts with the metal skin to complete the magnetic circuit.

6. A method according to claim 1, wherein the heat source is a radiant heat source which is applied to the surface of the test panel for a pre-defined period of time in order to raise the temperature of the panel at the point of application by a pre-defined amount.

7. A method according to claim 1, wherein the heat dissipation is measured by measuring the thermal radiation emitted from heated portion of the surface of the test panel.

8. A method according to claim 7, wherein said heat dissipation measurements are taken at intervals throughout the thermal decay cycle of the test panel, preferably until it has substantially reached ambient temperature and preferably at least ten distinct readings are taken at equally spaced time intervals.

9. A method according to claim 7 or claim 8, wherein said thermal radiation emission is measured using a thermal imaging device, the viewing area of said device being centred on the point of application of heat to the test panel and preferably being three times the diameter of the area over which the heat is applied to the surface of the panel.

10.-11. (canceled)

12. A method according to claim 1, wherein the surface of the test panel is struck with a tuned hammer in order to produce said pulse of energy.

13. A method according to claim 1, wherein said vibrations within the panel are monitored using an acoustic sensor capable of responding to frequencies at least one octave over the anticipated resonant frequencies.

14. A method according to claim 13, wherein the acoustic sensor takes measurements defining both the amplitudes and the frequencies of the vibratory modes.

15. (canceled)
